(19) United States
(12) Patent Application Publication
(10) Pub. No.: US 2014/0011163 A1
(43) Pub. Date: Jan. 9, 2014

(54) HAND-HELD VIBRATORY DISPENSING INSTRUMENT FOR APPLYING THERAPEUTIC COMPOSITIONS TO TEETH AND METHODS OF USING SAME

(71) Applicant: Oraceutical LLC, Lee, MA (US)

(72) Inventor: R. Eric Montgomery, Monterey, MA (US)

(21) Appl. No.: 13/935,440

(22) Filed: Jul. 3, 2013

Related U.S. Application Data
(60) Provisional application No. 61/667,564, filed on Jul. 3, 2012.

(51) Int. Cl. A61C 19/06; A61C 1/07

(52) U.S. Cl. CPC A61C 19/063; A61C 1/07
USPC 433/217.1

(57) ABSTRACT

A vibratory fluid dispensing instrument holds a rheologically non-Newtonian (shear-thinning) liquid, gel, cream, or paste therapeutic composition in a container section of a disposable applying device from which the composition is manually dispensed into an applicator brush for application to one or more surfaces in an oral cavity. The instrument includes a vibratory appliance mounted to the device and mechanically coupled thereto to enable application of the composition in conjunction with mechanical energy that reduces the viscosity of the composition due to vibratory shear forces and thereby leads to better penetration of the composition into hard and soft tissue surfaces. The vibratory appliance can be separate from the applying device so that it can be removed from an applying device after the container section is empty and reused with a replacement applying device.

### CROSS-REFERENCE TO RELATED APPLICATIONS

This application claims priority from U.S. provisional application No. 61/667,564, filed Jul. 3, 2012, the contents of which are incorporated herein by reference.

### BACKGROUND OF THE INVENTION

1. Field of the Invention

The present invention relates to a hand-held instrument for applying a dentally therapeutic composition to a biological surface in the oral cavity, and dental treatment methods using a dispensing instrument having a reservoir for containing the composition and including a vibratory function to assist in the application and distribution of a dentally therapeutic composition onto an oral cavity surface.

2. Background of Invention and Related Art

The application of dentally therapeutic compositions to the oral cavity may be accomplished in numerous ways, including brushing with a toothbrush, rinsing with a mouthwash, spraying with a fluid atomizer, or chewing gum or tablets that release active ingredients. In recent years, the use of pen-like devices has become a popular means of applying whitening gels or pastes to stained teeth for improving tooth color. Typically such devices have a reservoir for holding a whitening composition, an applicator such as a brush or felt tip insert connected to the reservoir, and a way of moving the whitening composition from the reservoir to and through the applicator and onto the tooth surfaces.

With these pens the effectiveness of the whitening composition depends wholly on the passive chemical effects of the composition itself. Moreover, most teeth whitening pens are used without protecting the applied composition from salivary and mechanical erosion from the teeth surfaces, so there is an inherently limited contact time for the composition to penetrate into the teeth before being washed away or otherwise removed. Accordingly, it would be advantageous to improve the penetration speed of whitening compositions, and dentally therapeutic compositions in general, dispensed by a pen or similarly designed applicator.

A principal aspect of the present disclosure is the result of discovering that applying certain dentally therapeutic compositions in fluid, gel, or paste form is enhanced in numerous unexpected ways if it is accompanied by the application of mechanical energy in the form of vibration. Although various kinds of vibratory applicators are known, none suggests key aspects of the present disclosure or overcomes the disadvantages of the known types of devices discussed above.

For example, vibratory applicators are known in the dental field, an example being shown in U.S. Pat. No. 5247,218. But the device of this patent is used only for applying thin coatings of liquid porcelain to dental crowns and bridges. It does not apply a dentally therapeutic composition, and has no reservoir or dispenser, and thus has no utility as a dispensing instrument that for applying a therapeutic composition from a reservoir in the instrument to surfaces in an oral cavity.

There are also known vibratory devices used to apply cosmetics. U.S. Pat. No. 8,033,746 relates to a vibrating pen device with a reservoir for holding and dispensing a cosmetic powder. This device relies solely on vibration to move the powder to a brush applicator, and thus would, have no utility for dispensing dentally therapeutic compositions in the form of liquids, gels, creams, or pastes. U.S. Pat. No. 8,177,450 describes a vibrating liquid makeup pen with a reservoir and an applicator, and having a vibratory function for massaging the skin while makeup liquid is applied. This device lacks a way of moving the liquid makeup from the reservoir to the applicator, so would not be relevant to problems faced in the prior art as discussed further above. Publ. No. US 2003/0171702 describes a vibratory massage device with a reservoir and an interface medium that is designed to apply a cosmetic composition on the skin while simultaneously applying vibration. While the interface medium can apply large quantities of cosmetics and/or medicaments to the skin, it would not he suitable for applying the much smaller quantities of liquids, gels, creams, or paste used in a dental environment.

Accordingly, there remains a need for an instrument for containing and applying therapeutic compositions to oral surfaces while using mechanical energy to enhance and accelerate the therapeutic action of the composition, as well as for methods of using the instrument to the same purpose and for compositions that can maximize the advantages of their application with such an instrument.

### SUMMARY OF THE INVENTION

The present disclosure has as one object the description of a novel instrument that has the unexpected advantage of improving the flow, distribution, and penetration of dentally therapeutic compositions when applied to one or more biological surfaces in the oral cavity by accompanying the application of the composition with vibratory mechanical energy.

A vibratory fluid dispensing instrument described herein is particularly useful when applying a rheologically non-Newtonian (shear-thinning) liquid, gel, cream or paste composition to one or more surfaces in the oral cavity, in that the reduction of viscosity of the composition due to vibratory shear forces leads to better penetration into hard and soft tissue surfaces.

Yet another unanticipated advantage of using a vibratory fluid dispensing instrument according to the present description is the mechanical disruption of biological surface biofilms at the same time that the composition that has been dispensed from the device is in contact with the teeth. In addition to enhancing the therapeutic action of the composition in these unexpected ways, the vibration is also advantageous because it massages soft tissues in the oral cavity, such as the gingival area around the margins of the teeth. Such massaging by the vibratory fluid dispensing instrument as described, herein can lead to an improvement in gingival tissue health by stimulating crevicular fluid and blood flow, particular in those applications where the composition contains an active ingredient targeting periodontal disease.

The description of the invention herein in connection with preferred embodiments will further illustrate various apparatus, composition, and method aspects of the described exemplary embodiments that enable realization of the numerous objects of the invention. In that regard, this Summary is provided to introduce a selection of concepts in a simplified form that are further described below in the description of embodiments that follows. This Summary is not necessarily intended to identify key features or essential features of the claimed subject matter, nor is it intended to be used as an aid in determining the scope of the claimed subject matter.

### BRIEF DESCRIPTION OF THE DRAWINGS

The objects of the invention will be better understood from the detailed description of its preferred embodiments which follows below, when taken in conjunction with the accompanying drawings, in which like numerals and letters refer to like features throughout. The following is a brief identification of the drawing figures used in the accompanying detailed description.

FIG. 1 is an isometric view of a hand-held dispensing instrument comprising a composition applying device and separate vibration appliance fir imparting vibratory energy to the device while the composition is being applied to a user's teeth.

FIG. 2 is a cross section of the device in FIG. 1 without the vibrating appliance, taken along the length of the device.

FIG. 3 is an exploded isometric view of the device in FIG. 1 showing the applying device and the separate vibration appliance of the present embodiment.

FIGS. 4, 5, and. 6 are detail views of respective embodiments of applicator brushes incorporated into the device shown in FIG. 3.

FIG. 7 is an isometric view of an alternate embodiment of the instrument shown in FIGS. 1 to 3 with the vibrating appliance integrated with the applying device.

FIG. 8 is an isometric view of the instrument shown in FIG. 7, partially exploded to illustrate the integration of the vibration appliance of the previous embodiment into the applying device.

FIG. 9 is a cross section of another embodiment of an instrument with a built-in vibration mechanism.

Those skilled in the art will readily understand that the drawings in some instances may not he strictly to scale and that they may further be schematic in nature, but nevertheless will find them sufficient, when taken with the detailed descriptions of preferred embodiments that follow, to make and use the present invention.

### DETAILED DESCRIPTION OF EXEMPLARY EMBODIMENTS

The detailed description that follows is intended to provide specific examples of particular embodiments illustrating various ways of implementing the claimed subject matter. It is written to take into account the level of knowledge of one of ordinary skill in the art to which the claimed subject matter pertains. Accordingly, certain details may be omitted as being unnecessary for enabling such a person to realize the embodiments described herein.

It should also be understood that the description herein is set forth only to illustrate exemplary embodiments of the claimed subject matter, and in no way limits such subject matter to what may be referred to herein as preferred or possible ways of practicing the same. Moreover, the present disclosure is written for those skilled in the art to which the claimed subject matter is directed, and is not intended as a primer on the manufacture of tooth whitening compositions or their use, or on devices for using such compositions. Accordingly, certain basic concepts and standard features of devices or compositions well known to those practicing in the field are not set forth in detail. Likewise, exhaustive descriptions of principles involved in practicing the claimed subject matter, such as choosing appropriate construction materials or ingredients, operating conditions, manufacturing techniques, electrical circuitry, electronic components, software/firmware that perform the functions described herein, and so forth, are omitted for the sake of brevity. Those skilled in the art will readily determine all of the information required to implement the claimed subject matter from the description herein, and attention is directed to appropriate texts and references known to those skilled in the art for details regarding any concepts and principles not covered in detail herein that may be required in the practice of the claimed subject matter. For example, basic information on the chemistry of tooth whitening and tooth whitening compositions may be found in reference works such as the Kirk-Othmer Encyclopedia of Chemical Technology, 4th Edition, Volumes 4 (1992), 13 (1995), and 18 (1996), John Wiley & Sons, NY; Goldstein and Garber, Complete Dental Bleaching, Quintessence Publishing Co. (1995); and the Journal of the American Dental Association, Vol, 128, Special Supplement (April 1997). The disclosures of these reference works are incorporated by reference to the extent they provide background information that might aid in understanding the discussion that follows.

### Overall Description of Illustrated Embodiments

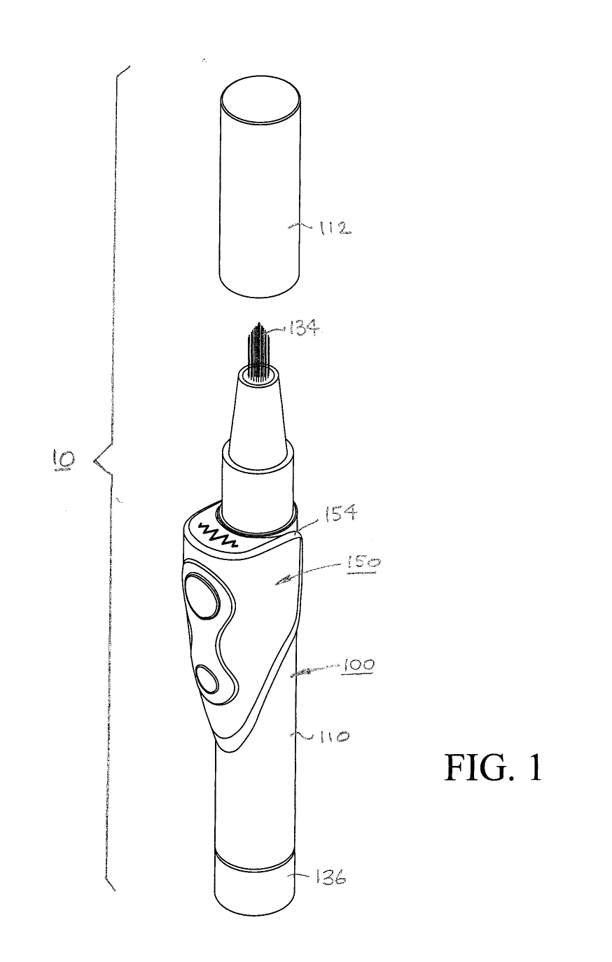

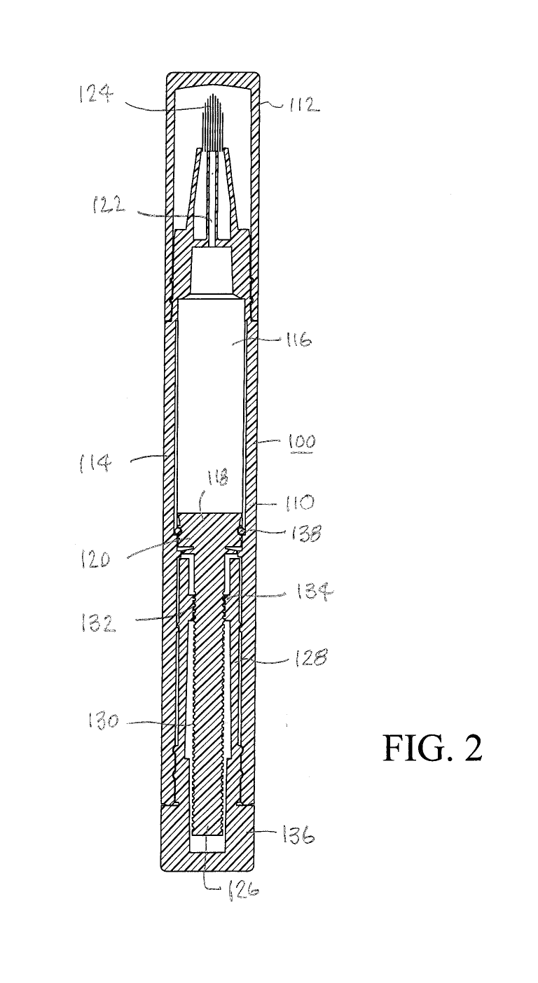

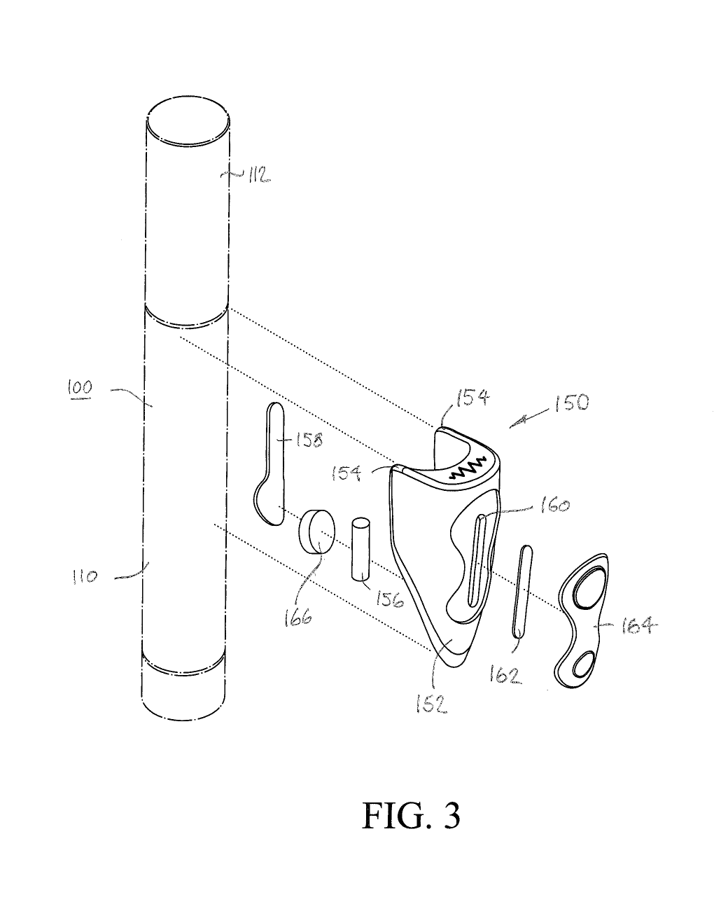

FIG. 1 is a perspective view of a hand-held instrument 10 in accordance with the presently described embodiment of the invention. The instrument 10 of this embodiment includes an applying device 100 that has a body portion 110 and a cap 112, which will he described just below in connection with FIG. 2. The other principal component of the instrument 10 is a vibration appliance which in the present embodiment is detachable from the applying device 100 in a manner described further below in connection with FIG. 3.

FIG. 2 is a schematic sectional view of the applying device 100. The body portion 110 comprises a tube 114 with a circular cross section that contains the various operative parts of the body portion 110. These include a container section 116 for a composition described further below that is applied using the instrument 10 in accordance with method aspects of the invention, also described further below. An applicator plunger 118 has a piston 120 at a distal end that slides inside the container section 116 to dispense the composition through an outlet 122 into a brush 124. The plunger 118 further includes an actuating rod 126 that extends from the piston 120 into an actuating sleeve 128 mounted for rotation about its longitudinal axis inside the tube 114. The actuating rod 126 has external threads 130 along its length that cooperate with internal threads 132 on a portion 134 of the rotatable actuating sleeve 128. The actuating sleeve 128 includes an actuating dial 136 at a proximal end of the sleeve 128. The piston includes restraints 138 that prevent it from rotating relative to the tube 110 as the dial 136 is manually rotated, thereby moving the piston 120 toward the outlet 122 and dispensing the contents of the container section 116 into the brush 124. As will be appreciated as the description proceeds, the brush 124 serves as an applicator member for the composition in the container section 116. The piston 120 is made of a suitable material that forms a sliding seal with the inside wall of the container section 116 of the tube 114.

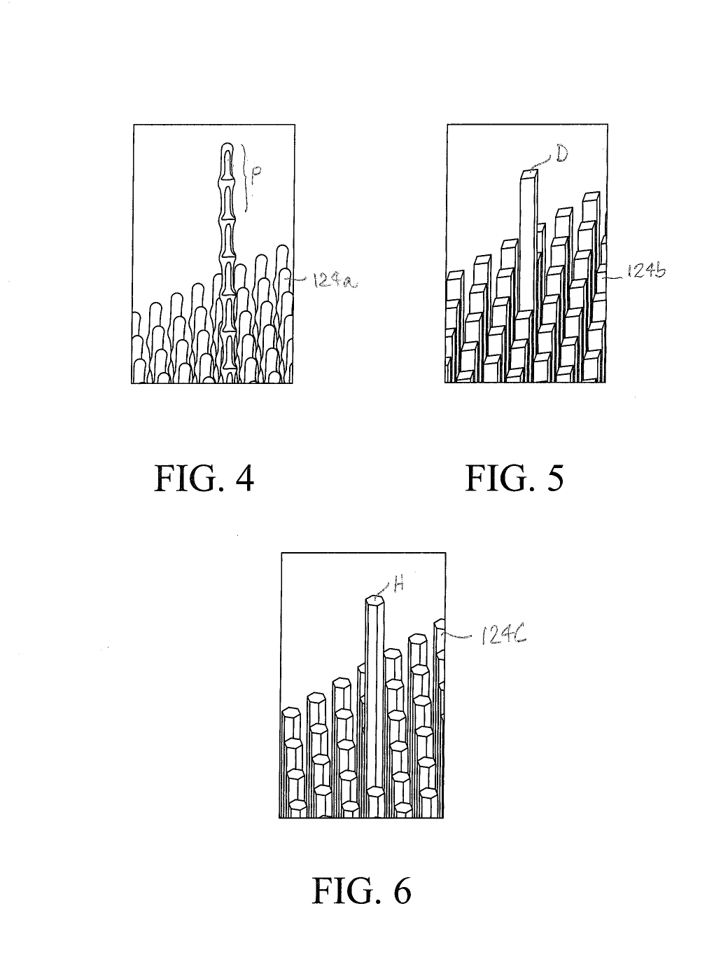

The brush 124 comprises a number of individual bristles and has a curved, conically shaped end as shown in FIGS. 1 and 2 that enable a user to effectively apply to desired tooth surfaces the composition forced through the outlet 122 into the inside of the brush 124. The bristles of the brush may have a configuration that enhances the effect of the composition applied in accordance with the method aspects of the invention, some examples of which are described in more detail below in connection with FIGS. 4 to 6. The cap 112 fits over the distal end of the tube 114 and clicks in place to protect the brush 124 when the instrument 10 is not in use. The cap 112 is designed to be easily removed and put back in place, as indicated in FIG. 1.

In the present embodiment the body portion 10 is made of materials and manufacturing methods (such as injected molded polymers) that enable the body portion to be sufficiently inexpensive to be disposable once the composition in the container section has been used up. However, those skilled in the art will appreciate that the body portion could be constructed so that the container section is refillable, or with a removable, replaceable container section, or with a container section designed to accept a pre-packaged composition dispensed from the package after it is placed within the body portion. Those skilled in the art will realize that numerous construction details are omitted for the sake of brevity and clarity, but that the description above and the depiction in the drawings will be sufficient to make an applying device with the described functions. For example, the exact nature of the sliding seal between the inside wall of the container section 116 and the piston 120 is omitted since one skilled in the art will be able to provide such a seal that will enable the device to perform the functions ascribed to it herein.

A significant advantage of the embodiment in FIGS. 1 to 3 is the use of a separate vibratory appliance 150 to impart the vibration that comprises an important part of the method aspects of the invention. As seen in FIG. 3, the vibratory appliance 150 comprises an appliance body 152 with a curved inner surface that fits snugly around the outside surface of the tube 114. The ends 154 of the appliance body 152 are configured to frictionally engage the outside of the body portion 110 and to extend just beyond the point of maximum diameter of the tube 114. If desired, the inner surface of the vibratory appliance body between the ends 154 can have a radius of curvature that matches the radius of curvature of the outside surface of the tube 114, and can also have small bumps that fit within depressions in the tube to more positively hold the body 152 in place on the applying device 100. The vibration appliance body 152 is made of a material that will deform slightly as the ends 154 are pressed against the outside to the tube 114, thus holding the appliance body into contact with and closely coupled mechanically to the applying device 100. Other constructions for intimately coupling the vibratory appliance to the applying device can be readily devised by those skilled in the art.

The appliance body 152 has a vibratory motor 156 disposed in a cavity (not shown) in the appliance body. The vibratory motor 156 fits wholly within the cavity and has a motor shaft that carries an eccentric mass. The motor is bonded securely to the inside surface of the cavity in a manner that effectively embeds the motor in the appliance body so that the vibration generated by rotation of the motor's eccentric mass is transferred directly to the appliance body with minimal energy loss. The cavity closed by a cover 158 that is also securely bonded to the appliance body. The cover 158 can be slightly raised from the inside surface of the vibration appliance body to enhance the mechanical coupling between the motor 156 and the applying device 100. The vibratory motor 156 is most conveniently a commercially available product. In a preferred embodiment the motor's eccentric mass rotates at an angular velocity between 8,000 and 16,000 rpm (that is, at a frequency between about 130 to 270 Hertz). Preferred frequencies of vibration can range between 100 and 2,000,000 Hertz, depending on the application.

The outer surface of the appliance body (that is, the surface not facing the applying device) has a switch cavity 160 into which fits an ON/OFF switch 162, and which is dosed by a flexible boot 164 that seals the switch cavity against, the introduction of any foreign material or moisture. The boot 164 is typically made of a soft, pliable material such as a thermoplastic polymer or elastomer, and is placed so that when the vibratory appliance is in place on the applying device, a user's finger or thumb falls naturally on the flexible boot. The ON/OFF switch 162 will typically only turn on the motor 156 when a user applies pressure to an area on the boot marked to indicate that pressing it will initiate vibration. An example of such a marking would be the word ON, with raised embossing that assists the user in locating the proper area for actuating the motor. The vibratory appliance includes a battery compartment (not shown) that holds a battery 166 for powering the motor 156. In a preferred embodiment the battery is rechargeable. FIG. 3 shows the battery location in schematically. In various constructions the battery will be positioned to provide the compact nature of the vibratory appliance 150 that realizes the advantages of using it with replacement applying devices, as discussed below in more detail.

It will be appreciated that the present embodiment advantageously combines a self-contained applying device that enables a user to dispense a therapeutic composition and includes no electrical parts. The applying device includes only simple mechanical parts made from inexpensive materials, thus rendering the applying device itself disposable. Thus, it avoids the inconvenience of requiring the user to refill the applying device with the consumable therapeutic composition, which makes it particularly useful as a consumer item (as opposed to being limited to use in a professional setting, such as a dentist's office). The instrument places relatively more expensive electrical components (vibration motor, battery, switch, circuitry, etc.) in a separate vibratory appliance to provide the advantages of using mechanical energy in the form of vibration while applying the therapeutic composition in accordance with the method aspects of the invention discussed further below. That is, the vibratory appliance is simply removed from a used applying device in which the consumable therapeutic composition is depleted and placed on a new applying device.

The capacity of the container section 116 is a matter of choice, but for most applications, one preferred range being a volume sufficient to hold about 0.5 milliliters (mL) to about 100 mL of the composition to be applied according to the methods described herein. A preferred capacity, particularly for a disposable applying device, is from about 1.5 mL to about 5.0 mL, with ranges in other configurations varying from about 1.0 mL to about 50 mL, or more preferably from about 2.0 mL to about 10 mL or even from about 3.0 mL to about 5.0 mL. In the present embodiment the vibratory appliance can be used repeatedly with numerous applying devices as the composition in each is used up. To that end, it is preferable that the battery 166 be rechargeable, although a disposable battery can also be used.

FIGS. 4 to 6 show exemplary bristle shapes for the applicator brush that can enhance the efficacy of the compositions and methods described herein. The brush construction preferably comprises closely packed Tynex® monofilaments available from DuPont Filaments-America, LLC, of Washington, WV (brochure http://www2.dupont.com/Filaments/en_US/assets/downloads/Toothbrush/Oral %20Care.pdf). Bristle monofilaments for oral care implements are generally made from nylon 6-12, but may be made from any biocompatible polymer or copolymer with acceptable physical properties. Although round monofilaments are typically employed in oral care brush configurations, other monofilament shapes and contours are contemplated to have utility in the present invention.

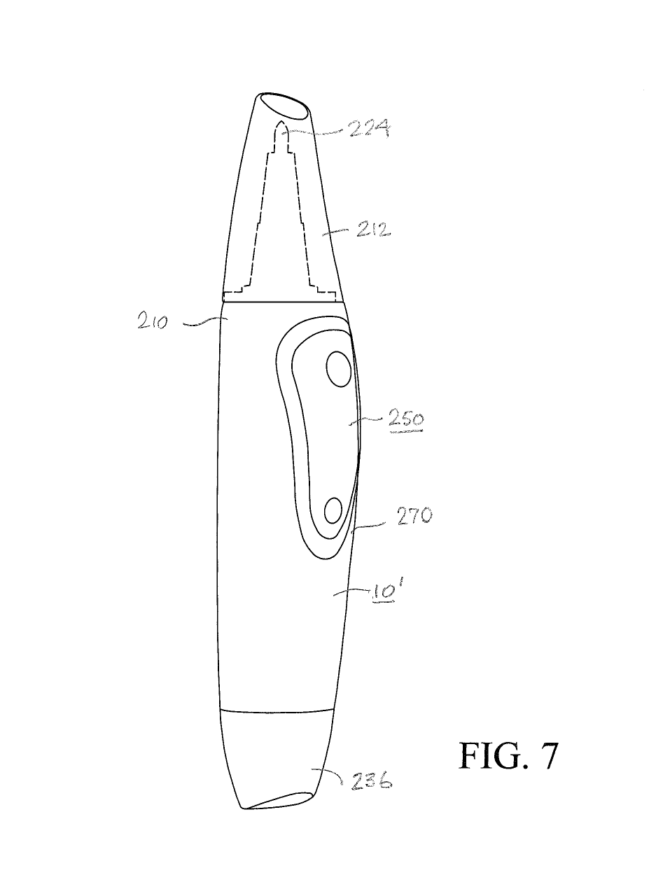

FIG. 4 shows a bristle configuration for a brush embodiment 124a that incorporates an embossed Tynex® filament that is believed to be particularly advantageous. Each filament, one of which is shown extended from its actual position for ease of illustration, has along its length a pattern P of indentations on one side and corresponding bumps on the other. According to the manufacturer, these indentations and bumps help carry the composition to the oral surfaces to be treated. More product information and further discussion is at http://www2.dupont.com/Filaments/en_US/assets/downloads/Toothbrush/Intr oducing%20embossed.pdf, incorporated herein by reference. FIG. 5 shows another brush embodiment 124b with bristles that are available in a Tynex® filament having a diamond-shaped (parallelogram) cross-section D said to more easily penetrate between teeth and below the gumline to provide more effective scrubbing and better cleaning of hard-to-reach back teeth areas. (In FIGS. 5 and 6, as in FIG. 4, one of the bristles is shown extended from its actual position for ease of illustration.) Additional information on this product is at http://www2.dupont.com/Filaments/en_US/assets/downloads/Toothbrush/Intr oducing%20brillance.pdf, incorporated herein by reference. FIG. 6 shows another brush embodiment 124c with bristles available in a Tynex® filament with a hexagonal cross section H. Information on DuPont™ filaments in general is in the brochure DuPont Filaments available at http://www2.dupont.com/Filaments/en_US/assets/downloads/Toothbrush/0ral %20Care.pdf, incorporated herein by reference.

Those skilled in the art will recognize that any bristle configuration and composition that can carry the therapeutic composition to the oral surface to be treated can be used in the present invention. In addition, the therapeutic composition need not be applied with a brush at all. The therapeutic composition applicator can also comprise a brush, a sponge, a felt material, a non-woven fabric, a molded polymer, a thermoplastic elastomer, or combinations thereof. Virtually any material suitable for application of compositions to biological surfaces in the oral cavity and which are well known in the art may be employed. However, the preferred applicator is a brush comprising Tynex® nylon monofilaments (such as those discussed above sold, having a cross-section dimension of from about 0.100 mm to about 0.500 mm in cross section, and a length of from about 2 mm to about 20 mm. As noted, monofilament bristles having a surface texture or shape designed to mechanically remove dental plaque, biofilm, and acquired pellicle are particularly preferred. Monofilaments containing an embedded abrasive may also be used to enhance the removal of films and stains from the surfaces of teeth.

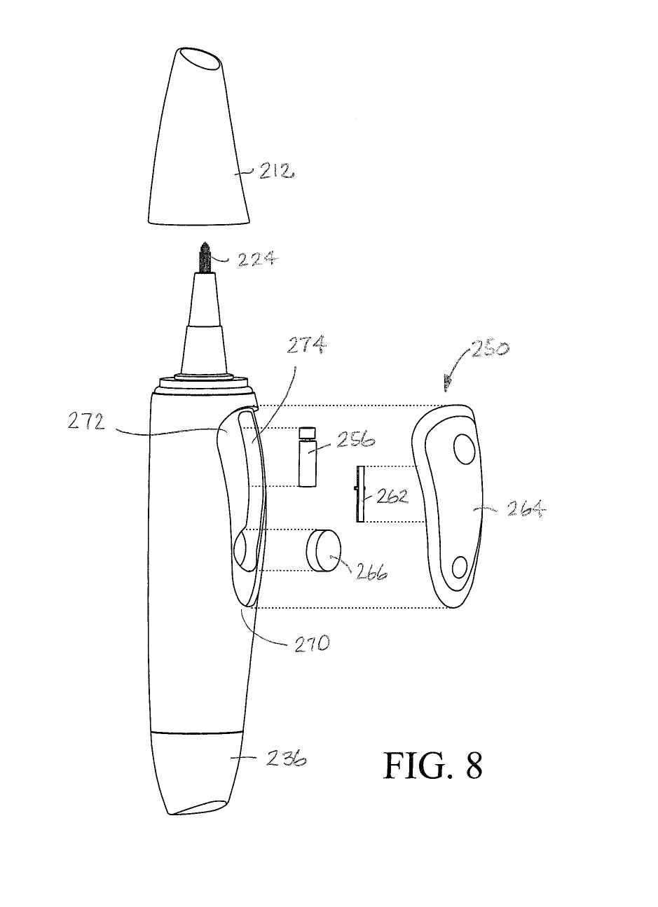

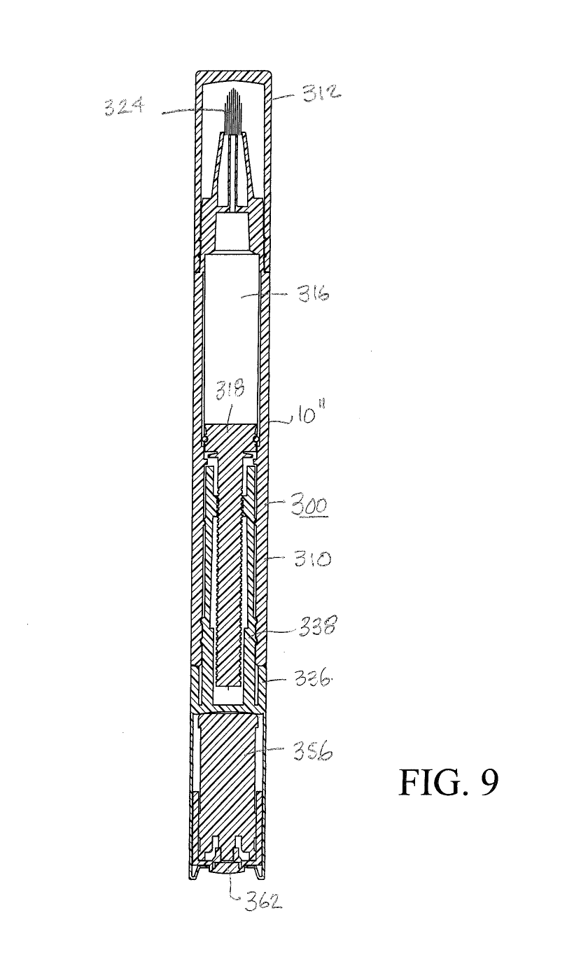

FIGS. 7 and 8 depict an alternate embodiment 10 of the instrument 10 described above in connection with FIGS. 1 to 3. In this alternate embodiment components that find counterparts in the previously described embodiment are identified as “200” series reference numerals to indicate comparable operational features. The instrument of this embodiment has a molded housing configured to enable incorporation of an applying device 210 and the vibratory appliance 250 in a single, integral unit. The dispensing mechanism (not shown) of this applying device has a similar structure to the applying device shown in FIG. 2, with a manually operated actuating dial 236 for dispensing the therapeutic composition contained in a container section.

Taking FIGS. 7 and 8 together, the body portion 210 has a slightly raised portion 270 on one side that has molded into it a recess 272 that accepts the boot 164 so that it lies flush with the surrounding surface of the body portion, as seen in FIG. 7. A slot 274 within the recess 272 holds the vibratory motor 256 closely coupled mechanically with the body portion by a suitable bonding technique that embeds the motor in a resin in the slot, similar to the manner in which the motor 156 is coupled to the body 152 of the separate vibratory appliance of the previous embodiment depicted in FIG. 3. A switch 262 is operated in a fashion similar to the switch 162 described above, and a battery 266 is disposed behind the boot 264, which seals the recess against the entry of moisture. Suitable electrical contacts (not shown) can be provided on the body portion 210 to enable the battery to be recharged.

The embodiment depicted in these two figures is more ergonomically suited for handling when activated to apply vibrational energy to an oral cavity than the previous embodiment in FIGS. 1 to 3. Additionally, since the FIGS. 7 and 8 embodiment comprises a body that almost completely covers the applying device, more economical materials and decoration may be used to construct the applying device in that it will not be seen during use. In addition, the embodiment depicted in FIGS. 7 and 8 allows for a much broader versatility of design, such as enabling different sizes to be made for different users, or rendering the applying device visible by making the cap 212 and/or the body 210 from a transparent or translucent plastic. Further, other desirable design features not possible with the embodiment of FIGS. 1 to 3 can be introduced by those skilled in the art.

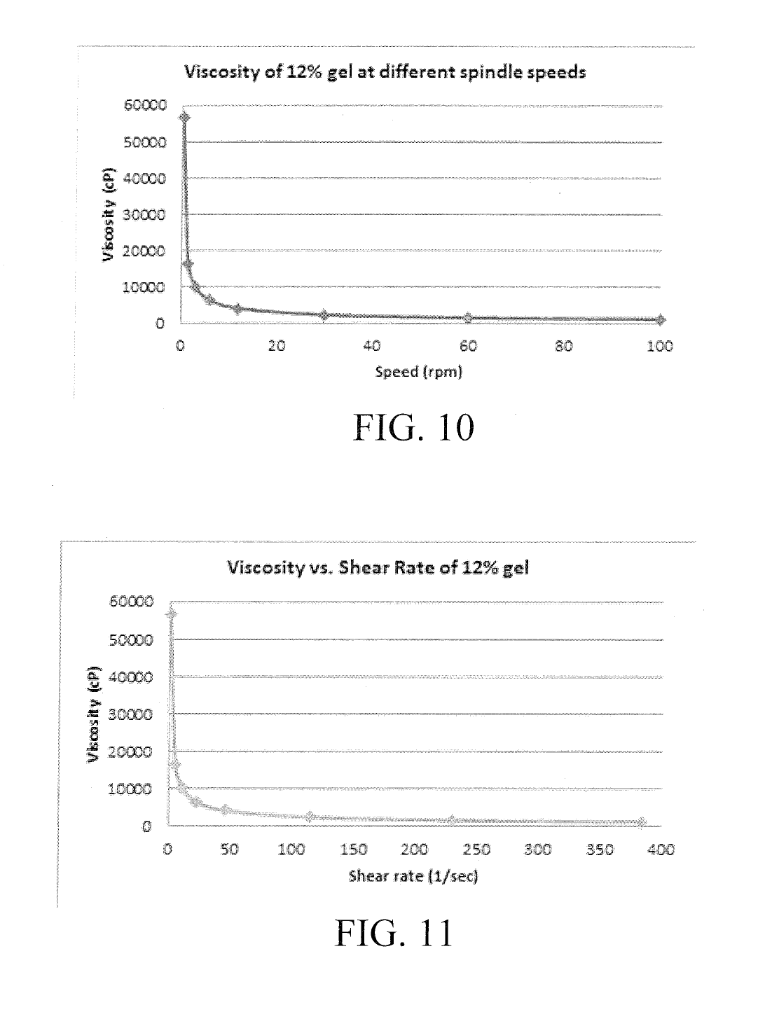

FIG. 9 depicts another alternate embodiment 10″ of the instrument 10 described above in connection with FIGS. 1 to 3. In this alternate embodiment components that find, counterparts in the previously described embodiment are identified as “300” series reference numerals to indicate comparable operational features. A principal difference between this embodiment and the embodiment of FIGS. 1 to 3 is the modified dial 336, which has been elongated to contain the vibratory motor 356 within an enclosure formed at the end of the instrument. The motor is held firmly against the end of the sleeve 338 to transmit the vibratory energy to the brush 324 at the other end. An ON/OFF switch is located at the end surface of the instrument, and suitable wiring is provided to actuate the motor. The battery (not shown) can be made accessible for recharging or replacement, or suitable contacts (not shown) can be provided on the body portion 310 to recharge the battery.

Those skilled in the art will appreciate that the instrument in accordance with this embodiment functions to deliver a therapeutic compositions as described herein, according to the below described method aspects of the invention, in a fashion similar to the previously described embodiments. An advantage of the embodiment depicted in FIG. 9 is that the vibratory and applying functions are combined into a single disposable unit, thereby eliminating the need to replenish the composition or keep track of a separate vibratory appliance, thus making it even more convenient for a user,

Therapeutic Compositions for Methods According to the Invention

An instrument according to the present invention can be used for applying an orally or dentally therapeutic composition in the form of a liquid, gel, cream, or paste comprising: (1) a toxicologically acceptable water-insoluble, water-resistant, or water-soluble carrier in the form of a liquid, gel, cream, or paste, (2) one or more orally or dentally therapeutic agents dissolved, dispersed, or otherwise homogeneously or heterogeneously distributed or dispersed throughout the carrier for the purpose of treating a disease, symptom, or condition or combination thereof when applied to at least one surface of the oral cavity, and (3) optional auxiliary ingredients. Two or more orally or dentally therapeutic agents may be employed within the same composition in order to treat multiple diseases, symptoms or conditions.

The one or more therapeutic agents dispersed in the carrier will be released from the carrier over a period of time once placed in contact with an oral cavity surface. The direction of agent release may be towards the oral cavity surface on which it is situated, towards the lumen of the oral cavity, away from the oral cavity surface on which it is situated, or both.

The therapeutic agent may be dissolved in the carrier or simply dispersed homogeneously in the carrier as an insoluble and suspended solid particulate. The therapeutic agent may also be emulsified with the carrier, creating separate and discrete phases within the composition. The emulsion may be either an agent-in-carrier emulsion or a carrier-in-agent emulsion, analogous to water-in-oil or oil-in water emulsions. The dental composition may also be a liquid, gel, cream, or paste emulsion with additional phases.

The therapeutic agent is placed in close proximity to the tissue surface, that is, dispersed or dissolved in a film of the carrier deposited by dispensing the inventive dental composition onto a target tissue surface. The composition of the carrier can be varied so as to provide the dental composition with a short, medium, or long residence time on the oral tissue surface. Solubility of the carrier composition in water (or in saliva) is a major predictor of the residence time for the resultant film deposited on an oral cavity surface. Rapidly dissolving films will release therapeutic agents faster than slowly dissolving or water-insoluble films. It may be desirable, in some cases, to prolong release of the therapeutic agent from the film by using a less water-soluble carrier composition; in other cases quick release of therapeutic agent may be preferred, and a highly water-soluble carrier composition is used for such applications.

The composition is in a liquid, gel, cream, or paste form at room temperature, defined herein as between about 20° C. and 30° C. (Celsius). The temperature of the oral cavity and its tissue surfaces is between about 30 and 39° C. Therefore, the dentally therapeutic compositions of this invention are preferably in the form of a liquid, gel, cream, or paste at temperatures between 20 and 40° C. In some cases, it may be desirable for the composition to be a gel, cream, or paste at temperatures up to about 85° C., which is nearing the maximum tolerable temperature for humans drinking hot potable liquids. Compositions with high melting temperatures will be more resistant to liquefaction if subjected to hot potable liquids while the film is in place in the oral cavity.

The above composition may be applied to one or more surfaces in the oral cavity, such as the teeth, gums, or tongue, to effect a therapeutic, curative, or cosmetic effect on or around the surface contacted. Once in contact with the surface (tooth, gingival tissue, etc.), the inventive composition may optionally be activated by the moisture in saliva by solubilizing, mobilizing, releasing, or otherwise activating the oral care therapeutic agent dispersed in the carrier. The activated therapeutic agent thus migrates out of the applied composition, and thus exerts the aforementioned therapeutic or cosmetic effect.

The liquid, gel, cream, or paste carrier may contain any number of water-insoluble, water-resistant, or water-soluble ingredients, including one or more of the following, either alone or in combination: water, glycerin, polyethylene glycol, propylene glycol, diglycerol, hydrogenated vegetable oils, waxes, fatty acid esters of glycerol, fatty acid esters of polyglycerol (including diglycerol esters and polyglycerol-3 esters), fatty acid esters of sugar alcohols (including sorbitan monostearate), fatty acid esters of polyethylene glycol, petrolatum, and other orally acceptable, water-insoluble or water-resistant, solid or semi-solid substances. A water-insoluble carrier will not dissolve in saliva but will eventually be removed from the teeth or gums by mechanical erosion. A water-resistant carrier is resistant to removal upon contact with an aqueous solution, but will slowly dissolve in saliva. A water-insoluble or water-resistant carrier preferably releases all or a substantial portion of the therapeutic agent before being eroded. The therapeutic agent is typically water soluble and is released from the carrier when water permeates into the film. Ingredients, such as poly(vinylpyrrolidone) (PVP), for example, may be added to make the carrier more readily absorb water.

Another type of liquid, gel, cream, or paste water-resistant carrier may be provided which contains a water-soluble fluid, gel, cream or paste, combined with a water-insoluble additive. One such composition comprises a water-soluble or partially water-soluble polyethylene glycol (PEG) liquid, gel, cream, or paste that includes one or more additives for rendering it water-resistant. Such additives may include oils, waxes, and polymers that possess limited water solubility, but are compatible, soluble, or otherwise dispersible in the PEG fluid, paste, or solid. Thus, the combined carrier composition described possesses limited solubility, and has utility in the practice of the overall invention.

Certain carrier embodiments may contain a water-resistant additive comprising a mixture of a high molecular weight water-soluble anionic polymer, such as carboxypolymethylene (Carbopol®, available from Lubrizol Corporation, Cleveland, Ohio)) or hydrolyzed or unhydrolyzed methyl vinyl ether/maleic anhydride copolymer (Gantrez®, available from ISP, Wayne, N.J.), either alone or together with a di- or trivalent ion such as calcium, zinc, or aluminum. Such ions may be present in the formulation as inorganic salts (such as calcium phosphate or zinc oxide) or organic salts (such as aluminum oxalate, calcium lactate or zinc lactate). Upon contact with moisture, the anionic polymer and the di- or trivalent ion become partially or completely solubilized, thereupon forming a water-resistant, crosslinked polymer structure. The resulting water-resistant structure further reduces the solubility of a liquid, gel, cream, or paste carrier as described above, the result being increased resistance to erosion of the composition after applied to an oral cavity surface, such as the teeth or gums. Alternatively, a composition comprising a high molecular weight water-soluble anionic polymer can be applied to the tooth or gum surfaces, and subsequently and sequentially contacted with a second composition comprising a di- or trivalent ion as described above in order to achieve the same degree of insolubilization of the anionic polymer on the tooth or gum surface.

The use of a water-insoluble or water-resistant carrier further supports stability of the dental composition and therefore lends to a longer shelf-life than compositions not including these carriers. A preferred shelf life ranges from six months to five years.

The concentration of carrier in the composition may be about 10%, 15%, 20%, 25%, 30%, 35%, 40%, 45%, 50%, 55%, 60%, 65%, 70%, 75%, 80%, 85%, 90%, 95%, 96%, 97%, 98%, 99% weight to weight of the composition.

Therapeutic agents useful when applied to the oral cavity include those known to be effective against tooth decay or caries, tartar or calculus, dental plaque, halitosis, tooth stains, gingivitis, periodontal disease, oral ulcers, and other diseases, afflictions, or symptoms of the oral cavity. Therapeutic agents may include antimicrobial agents, tooth whiteners, anti-inflammatory agents, tooth desensitizers, anticaries agents, tartar control agents, tooth and gum surface protectants, and tooth stain prevention agents, for example.

Suitable antimicrobial agents known or anticipated to have utility in the inventive compositions include compounds with inhibitory activity against microorganisms found in the oral cavity. Compounds such as triclosan, chlorhexidine salts (such as chlorhexidine digluconate), cetylpyridinium chloride and domiphen bromide are suitable antimicrobial agents useful in the present inventive compositions.

Suitable tooth whitening agents include one or more peroxide-containing compounds, or more broadly, oxidizing compounds. Such oxidizing compounds include alkali metal percarbonates (such as sodium percarbonate carbamide peroxide, sodium perborate, potassium persulfate, calcium peroxide, zinc peroxide, chlorine dioxide, sodium chlorite, hydrogen peroxide complexes (such as a PVP-hydrogen peroxide complex) and hydrogen peroxide.

Suitable anticaries agents include but are not limited to a source of fluoride ions. Fluoride sources include sodium fluoride, potassium fluoride, calcium fluoride, stannous fluoride, stannous monofluorophosphate and sodium monofluorophosphate. These sources should release anywhere from about 25 to about 3500 ppm of fluoride ions. The anti-caries agent may be present in an amount from about 0.05% to about 3.0%, preferably about 0.2% to about 1.0% by weight of the dental composition.

Suitable tartar control agents include but are not limited to zinc salts (e.g. zinc citrate trihydrate) and agents containing phosphorous (e.g. sodium tripolyphosphate). Inorganic phosphorous tartar control agents may include any of the pyrophosphates such as disodium pyrophosphate, dipotassium pyrophosphate, tetrapotassium pyrophosphate, tetrasodium pyrophosphate, and mixtures thereof. Organic phosphorous compounds that may serve as tartar control agents include phosphonates such as disodium ethane-1-hydroxy-1, 1-diphosphonate (EHDP), methanediphosphonic acid, and 2-phosphonobutane-1,2,4-tricarboxylic acid. Amounts of tartar control agents may range from about 0.5% to about 20.0%, preferably from about 1.0% to about 8.0%, optimally from about 1.2% to about 4.5% by weight of the dental composition. As an alternative to phosphates and phosphonates, zinc salts may be utilized as anti-tartar agents. Most preferred is zinc citrate trihydrate. Amounts of the zinc salt may range from about 0.5% to about 20%, preferably from about 1.0% to about 8.0%, optimally from about 2.0% to about 6.0%, by weight of the dental composition.

The concentration of therapeutic agent in the dental composition may be about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, 20,0%, 20.5%, 21.0%, 21.5%, 22.0%, 22.5%, 23.0%, 23.5%, 24.0%, 24.5%, 25%, 25.5%, 26.0%, 26.5%, 27.0%, 27.5%, 28.0%, 28.5%, 29.0%, 295%, 30.0%, 30.5%, 31.0%, 31.5%, 32.0%, 32.5%, 33.0%, 33.5%, 34.0%, 34.5%, 35.0%, 35.5%, 36.0%, 36.5%, 37.0%, 37.5%, 38.0%, 38.5%, 39.0%, 39.5%, 40.0%, 40.5%, 41.0%, 41.5%, 42.0%, 42.5%, 43.0%, 43.5%, 44.0%, 44.5%, 45.0%, 45.5%, 46.0%, 46.5%, 47.0%, 47.5%, 48.0%, 48.5%, 49.0%, 49.5%, 50% weight to weight of the composition.

Auxiliary ingredients contemplated for inclusion in the compositions of the present invention include thickeners, secondary film-forming agents, flavorants, humectants, sweeteners, surface active agents, emulsifiers, pH adjusting agents, stabilizing agents, secondary therapeutic agents, opacifying agents, colorants, and other product modifying or enhancing components

Suitable thickeners are well-known in the art and are preferably those polymers that exhibit non-Newtonian (shear-thinning) behavior in solution. An example of a non-Newtonian thickener is carboxypolymethylene (Carbopol® or Noveon®, Lubrizol Corp., Cleveland, Ohio). Suitable secondary film-forming agents include but are not limited to poly(vinyl pyrrolidone) (PVP), hydroxypropyl cellulose, hydroxyethyl cellulose, and methyl cellulose.

Suitable flavorants include but are not limited to oils derived from plants and fruits such as citrus oils, fruit essences, mint, peppermint oil, spearmint oil, capsaicin, clove oil, oil of wintergreen, anise, sassafras, sage, eucalyptus, marjoram, cinnamon, lemon, orange, banana, cherry, apple, pineapple, grape, strawberry, blueberry, tutti frutti, methyl salicylate, Hagelin flavoring #640047, Hagelin flavoring #640057, Hagelin flavoring #671009, Hagelin flavoring #671010, and. the like. Those skilled in the art will recognize that natural and artificial flavoring agents maybe used independently or combined in any sensoraily acceptable blend.

Suitable humectants include but are not limited to glycerin, sorbitol, mannitol, lactitol, maltitol, and other sugar alcohols, polyethylene glycol, propylene glycol, and other edible polyhydric alcohols and mixtures thereof.

Suitable sweeteners include but are not limited to sucrose, lactose, dextrose, maltose, dextrin, dried inverted sugar, fructose, levulose, galactose, corn syrup and their solids, sorbitol, mannitol, xylitol, hydrogenated starch hydrolysates, sucralose, aspartame, salts of acesulfame, alitame, saccharin and its salts, cyclamic acid and its salts, glycyrrhizin, dihydrochalcones, thaumatin, monellin, stevia extract and the like.

Suitable surface active agents include but are not limited to sodium lauryl sulfate, sodium methyl cocoyl taurate, condensates of sorbitan mono-oleate with from about 20 to 60 moles of ethylene oxide (e.g., “Tweens” a trademark of ICI United States, Inc.), an d condensates of ethylene oxide with propylene oxide and condensates of propylene glycol (“Pluronics” a trademark of BASF-Wyandotte Corp.).

Suitable pH adjusting agents include but are not limited to sodium hydroxide, potassium hydroxide, ammonium hydroxide, sodium carbonate, potassium carbonate, TRIS and triethanolamine.

Suitable stabilizing and/or chelating agents include but are not limited to EDTA and its salts, citric acid and its salts, gluconic acid and its salts, etidronic acid (Dequest® 2010 or Turpinal SL), alkali metal pyrophosphates and alkali metal polyphosphates

Suitable opacdymg agents include but are not limited to titanium dioxide, zinc oxide, amorphous calcium phosphate and hydroxyapatite.

Suitable colorants include but are not limited to FD&C-type dyes and lakes, fruit and vegetable extracts, titanium dioxide, and the like, alone or in combination.

The concentration of each auxiliary ingredient in the dental composition may be about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0,8%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%,160%, 16.5%, 17.0%, 17.5%, 18.0%, 18.5%, 19.0%, 19.5%, 20.0% weight to weight of the composition.

Additional carriers, therapeutic agents, and excipients useful in the invention are listed in Remington: The Science and Practice of Pharmacy (2000), Lieberman et al., Pharmaceutical Dosage Forms (2d ed. 1989), and The Merck Index (13th Ed.).

Methods for Whitening Teeth While Applying Vibrational Energy

The application of vibrational energy to an oral cavity surface previously or simultaneously contacted with a dentally therapeutic composition such as a teeth whitening gel produces a number of unexpected results. On the one hand, vibrational energy between 200 and 2,000,000 Hertz (oscillations per second) creates shear forces that can reduce the viscosity of a rheologically non-Newtonian fluid, gel, cream, or paste. Lowering the viscosity of a dentally therapeutic composition will encourage its flow and onto and penetration into oral cavity surfaces such as tooth enamel. In addition, if the vibrational energy is applied directly to an oral cavity surface covered with naturally-occurring biofilm, the vibrational energy can displace the biofilm thus exposing the biological tissue. In the case of tooth enamel, vibrational energy applied to the tooth surface using a brush, felt tip, or other textured applicator can displace or remove the acquired pellicle from the tooth surface, thereby exposing the underlying enamel surface devoid of biofilm. When the acquired pellicle is removed from the tooth surface, a dentally therapeutic composition may more readily penetrate into the enamel pores and interstices. in the case where a tooth whitening composition is applied together with biofilm displacement of the acquired pellicle accompanied by vibrational energy, rapid penetration of tooth enamel by the tooth whitening composition is observed. This rapid penetration leads to a more effective and efficient tooth whitening process, which is more acceptable to the user.

Thus, a preferred method of whitening teeth in accordance with the present invention comprises using an instrument as described above in connection with preferred instrument embodiments, comprising a dispensing or applying device comprising a container section or reservoir for a tooth whitening composition according to the composition embodiments described above, dispensing the composition onto the teeth surface while simultaneously applying vibrational energy to the teeth with the instrument to enhance the penetration and effectiveness of the composition. If the vibratory appliance is separate from the applying device, the method will include a step of assembling the vibratory appliance and the dispensing device to couple them together mechanically prior to the dispensing step.

An alternate method in accordance with the invention involves a pre-treatment step to displace biofilm on the teeth and/or gums that can hinder the penetration of the therapeutic composition. In one embodiment of this method, an abrasive acquired-pellicle-removing toothpaste may be brushed onto the teeth in a conventional manner with a toothbrush, followed by a separate step of applying a tooth whitening composition according to the methods previously described.

### EXAMPLES AND TEST RESULTS

The following examples and tests demonstrate the utility and efficacy of the present invention and the superior results it produces as compared to various known tooth whitening procedures. It will be understood that these examples do not limit the scope of the claimed subject matter, which is defined solely by the claims appended hereto.

### Example 1

### Tooth Whitening Compositions

The following is a tooth whitening composition suitable for dispensing from a vibratory applicator. All percentages shown in this and all subsequent examples are based on weights of individual ingredients added to the composition's total weight.

| Ingredient | Percent |
|---|---|
| Deionized water | 60.00 |
| Glycerin | 20.00 |
| Turpinal SL | 0.50 |
| Potassium stannate | 0.10 |
| Hydrogen peroxide | 12.00 |
| Carbopol 974P-NF | 2.00 |
| Sucralose | 0.30 |
| Cremophor RH60 | 3.00 |
| Flavor | 1.00 |
| Ammonium hydroxide 29% | 1.10 |
| Total | 100.00 |

Manufacturing Procedure: Combine water and glycerin, Turpinal SL, and potassium stannate; mix until dissolved resulting in a clear solution. Add hydrogen peroxide and mix well. Add Carbopol® by sifting into the vortex created by mixing with high speed agitation to disperse and dissolve. Continue mixing for a minimum of 60 minutes or until an opaque slightly viscous fluid is obtained. Transfer to a suitable double planetary or similar mixer and deaerate to remove air bubbles before neutralization. To neutralize, add 80% of the required ammonium hydroxide (added drop-wise through an open sight glass) as initial pH adjustment. Add sweetener and mix well. Melt the Creniophor® at around 40° C. and when liquefied add the flavor to this melt fluid and mix thoroughly. Add the Cremophor/flavor blend to the main mixture and mix thoroughly under a vacuum until a smooth translucent gel is obtained. Check pH and adjust to 4.9-5.2 with small increments of additional ammonium hydroxide, while continuing to deaerate to eliminate any entrapped air bubbles. The resulting mixture is a clear to slightly translucent non-Newtonian gel with a mint-like odor. Place into the container/reservoir section of an applying/dispensing device in accordance with the present description.

### Example 2

### In Vitro Viscosity Reduction and Improvement of Flow of a Non-Newtonian Hydrogen Peroxide Gel Subjected to Shear Stress

The gel of Example 1 was tested for its non-Newtonian property of viscosity reduction due to applied shear stress as follows.

Objective: In order to replicate the effect of increased shear rate due to vibratory motion on non-Newtonian semi-solids, this experiment determined the viscosity of the non-Newtonian hydrogen peroxide teeth whitening gel of Example 1 when subjected to a range of shear forces in a standard Brookfield Cone-Plate viscometer.

Methods: The viscosity of a 0.5 mL sample of a 12% hydrogen peroxide gel (Smileactives® Vibrite® Clinical Strength Teeth Whitening Gel, Oraceutical LLC, Lee, Mass. 01238) was measured at a constant temperature of 25° C. and various spindle speeds using a Wells-Brookfield Cone-Plate Viscometer (Model RVDV-1PCP/Spindle CPE-51Z, Brookfield Engineering, Middleboro, Mass. 02346). Spindle speeds of 0,3, 1.5, 3, 6, 12, 30, 60 and 100 rpm were used to develop curves of viscosity vs. spindle speed and viscosity vs, shear rate. Increases in shear rate correspond to the vibratory motion of an object, such as a brush bristle, passing through a fluid or semi-solid and therefore can be replicated by the present model.

Results: The viscosity of the non-Newtonian 12% hydrogen peroxide gel showed a dramatic reduction in viscosity as the spindle speed and thus the shear rate was increased (see Table 1 below). As shown in FIGS. 10 and 11, the viscosity of the test gel was reduced almost 50-fold as the spindle speed and shear rate was increased from 0.3 rpm to 100 rpm.

TABLE 1

| Speed | Viscosity | Shear Rate |
|---|---|---|
| (rpm) | (centipoise) | (1/sec) |
| 0.3 | 56,613 | 1.15 |
| 1.5 | 16,570 | 5.76 |
| 3 | 10,218 | 11.5 |
| 6 | 6,421 | 23 |
| 12 | 4,142 | 46.1 |
| 30 | 2,389 | 115 |
| 60 | 1,609 | 230 |
| 100 | 1,205 | 384 |

Discussion: There is a direct correlation between viscosity and penetration of fluids and gels into tooth enamel, as shown by Irinoda et al., “Effect of sealant viscosity on the penetration of resin into etched human enamel,” Oper. Dent, 2000, July-August; 25(4), pages 274-82, and others. While the exact chemical composition of a substance in contact with the tooth surface will present other factors responsible for providing good vs. poor penetration (surface tension, water content, molecular weight of active ingredient(s), presence of hydrophilic and hydrophobic constituents, etc.), lowering the viscosity of a given composition will in most instances increase the rate of penetration into the tooth enamel. When a non-Newtonian fluid or semi-solid medium is subjected to an increase in shear rate resuking from the movement of an object or series of objects through the medium, the reduction in viscosity leads to improved flow and penetration into porous substrates such as tooth enamel.

Conclusion: Viscosity reduction and thus improved flow properties of a non-Newtonian 12% hydrogen peroxide teeth whitening gel can be achieved by subjecting it to an increase in shear forces. Shear forces tested in this study are comparable to those generated by the transverse movement of a vibratory device comprising a source of vibrational energy at a frequency of between about 100 and 2,000,000 Hertz

### Example 3

### Tooth Whitening Clinical Study Comparing Results Obtained with and Without the Use of a Vibratory Applicator Device

A clinical study was undertaken to compare the tooth whitening results obtained with and without the use of a vibratory applicator instrument in accordance with the present invention. Ten subjects were selected with healthy dentition and a stain index of A3 or darker on the VITA® shade guide (Vita Zahnfabrik). The ten subjects were placed in two groups of five and starting shade averages for the two groups were normalized to obtain similar starting points. Five subjects were given a vibratory tooth whitening pen (Smileactives® Vibrite Tooth Whitening Pen) according to the embodiment depicted in FIG. 9, which contained the 12% hydrogen peroxide tooth whitening gel of Example 1. The remaining five subjects were given a regular tooth whitening pen without the vibratory function (Smileactives® Clinical Strength Tooth Whitening Pen) containing the same 12% hydrogen peroxide tooth whitening gel of Example 1. Subjects were instructed in the proper use of their respective tooth whitening instruments, and to apply the gel with or without the vibratory function, depending on the study group, four times daily for a period of one week.

Results: None of the study subjects experienced any sensitivity or irritation as a result of applying the gel of Example 1 to their teeth and gums. All subjects were able to complete the study. After one week, the group of subjects using the non-vibratory tooth whitening pen showed an average VITA® shade change of 4.5 shades, while the group of subjects using an instrument according to the present invention showed an average VITA® shade change of 5.8 shades. This represents a 29% improvement in whitening compared to the non-vibratory pen group, demonstrating the enhancement of subject teeth whitening caused by the vibratory energy applied to the gel.

Conclusion

It will be understood that the embodiments of the invention described above can be modified in myriad ways other than those specifically discussed without departing from the scope of the invention. For example, vibratory energy may be used to enhance the activity of virtually any therapeutic non-Newtonian composition by increasing its penetration into an underlying biological surface by reducing its viscosity. In addition, the selection of vibratory frequency may be specific to a particular biological surface, therapeutic composition, or combination thereof to optimize the therapeutic effect.

Those skilled in the art will readily recognize that only selected preferred embodiments of the invention have been depicted and described, and it will be understood that various changes and modifications can be made other than those specifically mentioned above without departing from the spirit and scope of the invention, which is defined solely by the claims that follow.

What is claimed is:

1. A method of applying a therapeutic composition to a biological surface in an oral cavity, the method comprising:
obtaining a hand-held instrument with an applying device having a container section and a vibratory appliance mechanically coupled to the applying device;
filling the container section with an orally therapeutic composition; and
applying the therapeutic composition by dispensing the composition from the container section onto one or more biological surfaces in the oral cavity while operating the vibratory appliance.

2. The method of claim 1 wherein the orally therapeutic composition is a non-Newtonian fluid, gel, or paste that decreases in viscosity when subjected to vibration.
